(19) United States
(12) Patent Application Publication
(10) Pub. No.: US 2012/0062670 A1
(43) Pub. Date: Mar. 15, 2012

(54) PHASE CHANGE INK COMPOSITION

(75) Inventor: Feng Gao, Hockessin, DE (US)

(73) Assignee: E.I. DU PONT DE NEMOURS AND COMPANY, Wilmington, DE (US)

(21) Appl. No.: 13/319,789

(22) PCT Filed: May 19, 2010
(86) PCT No.: PCT/US10/35398

§ 371 Date: Nov. 10, 2011

Related U.S. Application Data
(60) Provisional application No. 61/179,736, filed on May 20, 2009.

(51) Int. Cl. B41J 2/01; B41M 1/12; H01B 1/22; C09D 11/02; C09D 11/12

(52) U.S. Cl. 347/102; 106/31.92; 252/514; 101/129

(57) ABSTRACT

The present invention relates a composition which is useful in printing an electrical conductor on the front surface of a substrate, such as a solar cell. A phase change binder is used to allow printing of narrow grid lines which also may have adequate height to provide sufficient electrical conduction. The present invention is also directed to a process to print a pattern of the composition.

### FIELD OF THE INVENTION

The present invention relates a composition which is useful in printing regions of electrical conductor on the front surface of substrates. A phase change binder is used to allow printing of narrow grid lines which also may have adequate height to provide sufficient electrical conduction.

### BACKGROUND OF THE INVENTION

There exist many thick film conductive pastes in the industry. For example, Konno (US200810254567) describes a thick film conductive composition comprising silver powder, zinc oxide, glass frit, and organic medium. Further described in Wang et al. (US200610231804) is a thick film conductive composition comprising silver powder, zinc containing additive, glass frit, and organic medium. Carroll et al. (U.S. Pat. No. 7,435,361) discloses a thick film conductive composition comprising silver powder, zinc containing additive, lead-free glass frit and organic medium.

Conventional conductive inks and pastes used in electronic materials are viscous at room temperature. Such inks and pastes typically consist of conductive powders or flakes and adequate additives dispersed in a liquid vehicle. Such pastes and inks are applied to substrates by conventional methods such as screen printing, pad printing, ink jet printing, and other application methods, which are well known. Screen printing is widely adopted for printing thick pastes on crystalline wafers for photovoltaic cells as the most common print method.

One of the problems associated with the use of screen printing on photovoltaic cells is that it creates conductor grid lines with low aspect ratios (height to width), around 0.1. The wide grid lines block sunlight into the cells so that the cell efficiency is reduced. In addition, it is a contact printing method, which leads to some breakage of the wafer cells. Therefore, it is highly desirable to develop a printing method that is non-contact and can print narrow grid lines with high aspect ratio.

Therefore, there is a need for a composition to print high aspect ratio (height to width) grid lines with a height greater than 12 microns and width less than 120 microns (values are after firing process). The present invention fulfills the need.

### BRIEF DESCRIPTION OF THE FIGURES

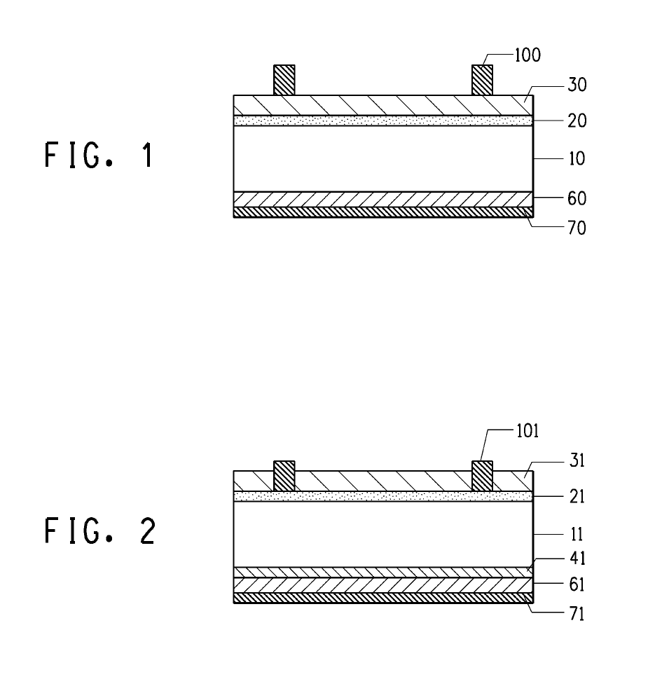

FIG. 1 illustrates a cross section diagram of a wafer solar cell (p-type wafer) before a firing process.
10: p-type silicon substrate
20: n-type diffusion layer
30: silicon nitride film, titanium oxide film, or silicon oxide film
60: aluminum paste formed on backside
70: silver or silver/aluminum paste formed on backside
100: silver paste formed on front side

FIG. 2 illustrates a cross section diagram of a wafer solar cell (p-type wafer) after the firing process.
11: p-type silicon substrate
21: n-type diffusion layer
31: silicon nitride film, titanium oxide film, or silicon oxide film
41: p+ layer (back surface field, BSF)
61: aluminum back electrode (obtained by firing backside aluminum paste)
71: silver or silver/aluminum back electrode (obtained by firing back side silver paste)
101: silver front electrode (formed by firing front side silver paste)

### SUMMARY OF THE INVENTION

The present invention is a composition comprising by weight based on total composition:

a) 30 to 98% silver powder having metal particles wherein the metal particles have an average particle size of 5 nm to 10 micron;

b) 0.1 to 15% of glass frit having frit particles wherein the frit particles have an average particle size of 5 nm to 5 micron;

c) 1 to 70% of a cross-linkable, phase change binder;

d) optionally, 0.1 to 8% of Zn containing particles wherein the Zn containing particles have an average particle size of 5 nm to 10 microns;

e) optionally 0.01 to 10% of initiator; and

f) optionally 0.0001 to 2% stabilizer.

The present invention is also a process comprising: depositing a pattern of the composition on a substrate, cross-linking the phase change binder, and firing the composition.

### DETAILED DESCRIPTION

A conductive phase change composition is described herein that can be cross-linked. Also, a print method using the conductive phase change composition is described that can produce conductor grid lines of high aspect ratio on wafers. Radiation curable binder allows maintaining the high aspect ratio of the grid lines formed when firing, while an ink jet print provides a non-contact technique with sufficient throughput. The composition and method of application is useful in the manufacture of solar cells.

In the art, it is known to use phase change compositions known as inks, also known as hot melt inks. In general, phase change inks at ambient temperature are in a solid phase, but exist in a liquid phase at the elevated operating temperature in an ink jet printing device. At the jet operating temperature, droplets of liquid ink are ejected from the printing device and, when the ink droplets contact a surface of a recording substrate, either directly or via an intermediate heated transfer belt or drum, they quickly solidify to form a predetermined pattern of solid ink drops. A printed pattern of lines can be cross-linked through radiation curing of the binder such as with UV light exposure, thermal treatment, e-beam exposure or combinations thereof because of the use of the phase change curable binder. The curing sets the composition; thus, spreading of the patterned lines is prevented when the lines are heated during firing of the wafers, e.g. up to 900° C.

Ink jetting devices are known in the art and thus extensive description of such devices is not given herein. As described in U.S. Pat. No. 6,547,380, incorporated herein by reference, ink jet printing systems generally are of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium.

There are at least three types of drop-on-demand ink jet systems. One type of drop-on-demand system is a piezoelectric device that has as its major components an ink-filled channel or passageway having a nozzle on one end and a piezoelectric transducer near the other end to produce pressure pulses. Another type of drop-on-demand system is known as acoustic ink printing. As is known, an acoustic beam exerts pressure against objects upon which it impinges. Thus, when an acoustic beam impinges on a free surface (i.e., the liquid/air interface) of a pool of liquid from beneath, the pressure which it exerts against the surface of the pool may reach a sufficiently high level to release individual droplets of liquid from the pool, despite the restraining force of surface tension. Focusing the beam on or near the surface of the pool intensifies the pressure it exerts for a given amount of input power. Still another type of drop-on-demand system is known as thermal ink jet, or bubble jet, and produces high velocity droplets. The major components of this type of drop-on-demand system are an ink-filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

Silver conductor lines printed from phase change inks having phase change binders exhibit high aspect ratios (height to width). However, when fired, the lines spread due to the melting of the polymer binder or waxy material in the paste. The composition uses binders and waxy materials that can be easily cross-linked before melting and spreading occurs. Radiation curable as used herein is intended to cover all forms of curing upon exposure to a radiation source, including light and heat sources and including the presence or absence of initiators. Examples of radiation curing routes include, but are not limited to: curing using ultraviolet (UV) light, for example having a wavelength of 200 to 400 nm or more rarely visible light, preferably in the presence of photoinitiators and/or sensitizers or stabilizers; curing using e-beam radiation, preferably in the absence of photoinitiators; curing using thermal curing, in the presence or absence of high temperature thermal initiators (and which are preferably largely inactive at the jetting temperature); and appropriate combinations thereof. UV curing is preferred. Phase change inks with zinc oxide and frit are particularly useful for printing conductors on the front (sun exposed) side of solar cells having antireflective coatings. Ink jet printing is an adequate printing method through the use of such a composition for achieving grid lines with high aspect ratio.

### Electrically Conductive Metal Particles

Generally, a conductive ink composition comprises conductive particles for conduction of electrons. Silver particles are preferred although other metals such as Cu, Ni, Al, Pd, or mixtures or alloys of these with Ag may be used. The particles can be spherical, platelets or flakes in shape. The metal particles may be coated or uncoated. When silver particles are coated, they may be at least partially coated with a surfactant. The surfactant may be selected from, but is not limited to, stearic acid, palmitic acid, a salt of stearic acid, a salt of palmitic acid, and mixtures thereof. Other surfactants may be utilized including lauric acid, oleic acid, capric acid, myristic acid, and linolic acid. The counter-ion can be, but is not limited to, hydrogen, ammonium, sodium, potassium, and mixtures thereof.

The particle size of the metal is not subject to any particular limitation, although an average particle size of no more than 10 microns, and preferably no more than 1 micron, is desirable. The particle size of about 5 to 500 nanometers is typically used. Particles less than 5 nm are typically very expensive, and are not usually considered for commercial use. The composition comprises 30 to 98% by weight of metal powders based on total composition. Preferably the metal content is between 40% and 80%.

### Zn Containing Particles

Zinc containing particles are optionally added as a functional component in combination with glass frit to etch through the front side antireflective coating layer (e.g., silicon nitride) and to form good contact with low contact resistance. The silicon nitride layer may be formed, for example, by thermal chemical vapor deposition (CVD), plasma-enhanced chemical vapor deposition (PECVD), or a sputtering process. Although ZnO is preferred, other Zn-containing particles may be used. The particles may be Zn, an oxide of Zn, a compounds that can generate an oxide of Zn upon firing, or mixtures of thereof. Preferably the particle size is less than 10 microns, more preferably it is less than 800 nm, and most preferably it is less than 300 nm. Particles less than 5 nm are typically too expensive to be considered for commercial uses. The composition comprises 0.1 to 8% by weight based on total composition, and preferably comprises 2 to 6% ZnO.

### Glass Frit

Examples of the glass frits which may be used in the present invention include amorphous, partially crystallizable lead silicate glass compositions as well as other compatible glass frit compositions. In a further embodiment these glass frits are cadmium-free. Additionally, in a further embodiment, the glass frit composition is a lead-free composition. An average particle size of the glass frit of the present invention is in the range of 5 nm to 5 microns in practical applications, while an average particle size in the range of less than 1.5 microns is preferred and less than 0.7 microns most preferred. The softening point of the glass frit (T_{c}, the second transition point in the DTA) should be in the range of 300 to 600° C.

The glasses described herein are produced by conventional glass making techniques known to those skilled in the art. More particularly, the glasses may be prepared as follows: Glasses are typically prepared in 500 to 1000 gram quantities. The ingredients are weighted, mixed in the desired proportions, and heated in a bottom-loading furnace to form a melt in a platinum alloy crucible. Heating is typically conducted to a peak temperature (1000 to 1400° C.) and for a time such that the melt becomes entirely liquid and homogeneous. The glass melts are then quenched by pouring them out onto the surface of counter rotating stainless steel rollers to form a 10 to 20 mil thick platelet of glass or by pouring into a water tank. The resulting glass platelet or water quenched frit is milled to form small particles. An average particle size of the glass frit of the present invention is preferred less than 1.5 micrometers, mostly preferred less than 0.7 micrometer. The composition comprises 0.1 to 15% by weight based on total composition, preferably 2 to 8% of the glass frit.

### Cross-Linkable, Phase Change Binder

The composition has a cross-linkable, phase change binder component. Although the curing may be accomplished through exposure of UV light or other means, such as e-beam or thermal curing, UV light curing is preferred. The cross linkable, phase change binder is a monomer, an oligomer, or mixtures thereof with one or more functional groups that may be cross-linked. Examples of such binders with one or more curable moieties include, but are not limited to, acrylates, methacrylates, alkenes, allylic ethers, vinyl ethers, epoxides such as cycloaliphatic epoxides, aliphatic epoxides and glycidyl epoxides, oxetanes, and the like. The binders are preferably monoacrylates, diacrylates, or polyfunctional acrylates.

Suitable monoacrylate monomers are, for example, cyclohexyl acrylate, 2-ethoxy ethyl acrylate, 2-methoxy ethyl acrylate, 2(2-ethoxyethoxy)ethyl acrylate, tetrahydrofurfuryl acrylate, octyl acrylate, lauryl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate, octyl decyl acrylate, ethoxylated nonylphenol acrylate, hydroxyethyl acrylate, hydroxyethyl methacrylate, and the like. Suitable polyfunctional alkoxylated or polyalkoxylated acrylates are, for example, alkoxylated, preferably, ethoxylated, or propoxylated, variants of the following: neopentyl glycol diacrylates, butanediol diacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, propoxylated neopentyl glycol diacrylate, ethoxylated neopentyl glycol diacrylate, cyclohexane dimethanol diacrylate, tris(2-hydroxy ethyl) isocyanurate triacrylate and the like. In the most preferred embodiment, the monomers are cyclohexane dimethanol diacrylate (CD 406 from Sartomer Co., Inc., Exton, Pa.), and tris(2-hydroxy ethyl) isocyanurate triacrylate (SR 368 from Sartomer). The preferred monomers or oligomers or mixture thereof are liquid at ink jet printer operating temperatures (heating chamber and print head temperatures) and solid at 25° C. The ink jet printer operating temperature is preferably 50 to 240° C., more preferably 60 to 150° C. and most preferably 70 to 120° C. Preferably the monomer has a sharp melting point or melting behavior and high crystallinity.

Suitable curable oligomers include, but are not limited to, acrylated polyesters, acrylated polyethers, acrylated epoxies, urethane acrylates, and pentaerythritol tetraacrylate. Specific examples of suitable acrylated oligomers include, but are not limited to: acrylated polyester oligomers, such as CN2262 (Sartomer), EB 812 (UCB Chemicals Corp., Smyrna, Ga.), CN2200 (Sartomer), CN2300 (Sartomer), and the like; acrylated urethane oligomers, such as EB270 (UCB Chemicals), EB 5129 (UCB Chemicals), CN2920 (Sartomer), CN3211 (Sartomer), and the like; acrylated epoxy oligomers, such as EB 600 (UCB Chemicals), EB 3411 (UCB Chemicals), CN2204 (Sartomer), CN110 (Sartomer), and the like; and pentaerythritol tetraacrylate oligomers, such as SR399LV (Sartomer) and the like. Molecular weight (Mw) of the oligomers is preferably less than 8000, more preferably less than 5,000. In another embodiment, preferably the oligomeric binders are acrylates. It is preferred to incorporate less than 20% by weight of the oligomeric binders of the total amount of binder in the composition.

In another embodiment, the curable binder includes polymers, but not limited to, such as acrylated polyesters, acrylated polyethers, acrylated epoxies, and urethane acrylates.

Suitable reactive binders are likewise commercially available from, for example, Sartomer Co., Inc., Henkel Corp., Radcure Specialties, RadTech, and the like.

In another embodiment, a waxy material may be incorporated with the curable binders. As used herein, the term wax includes natural, modified natural and synthetic waxes. A wax is solid at room temperature, specifically at 25° C. Preferably the wax melts between 45 and 240° C., more preferably between 50 and 120° C. Examples of waxes include, but are not limited to, carnauba wax, beeswax, candelilla wax, ceresine and ozokerite waxes, paraffin and microcrystalline waxes, genuine Japan wax, and rice bran wax. They can be obtained, for example, from Strahl & Pitsch, Inc., West Babylon, N.Y. Poly(ethylene vinyl acetate), alcohols with more than 10 carbons, or an acid with more than 10 carbons may be used as waxes. Preferably, the wax has been modified with one or more curable functional groups, preferably acrylates. When wax without cross-linkable moieties is used, the wax content is preferably less than 50% (of the total binder and waxy materials).

The composition comprises 1 to 70% of the phase change binders based on total composition, and preferably, 3 to 45%.

### Initiator

In some embodiments, the composition optionally comprises an initiator, preferably a photoinitiator, which initiates polymerization of curable components of the ink. The initiator should be soluble in the composition. In preferred embodiments, the initiator is a UV-activated photoinitiator.

In some embodiments, the initiator is a radical initiator. Examples of suitable radical photoinitiators include, but are not limited to: ketones such as benzyl ketones, monomeric hydroxyl ketones, polymeric hydroxyl ketones, and a-amino ketones; acyl phosphine oxides, metallocenes, benzophenones, such as 2,4,6-trimethylbenzophenone, and 4-methylbenzophenone; and thioxanthenones, such as 2-isopropyl-9H-thioxanthen-9-one. A preferred ketone is 1-[4-(2-hydroxyethoxy)-phenyl]-2-hydroxy-2-methyl-1-propane-1-one. In a preferred embodiment, the ink contains a α-amino ketone, 1-[4-(2-hydroxyethoxy)-phenyl]-2-hydroxy-2-methyl-1-propane-1-one and 2-isopropyl-9H-thioxanthen-9-one.

In other embodiments, the initiator is a cationic initiator. Examples of suitable cationic initiators include, but are not limited to, aryldiazonium salts, diaryliodonium salts, triarysulfonium salts, triarylselenonium salts, dialkylphenacylsulfonium salts, triarylsulphoxonium salts, or aryloxydiarylsulfonium salts.

The total amount of initiator included in the composition is, for example, about 1 to about 10%, preferably from about 3 to about 10%, by weight based on total composition.

### Stabilizers and Optional Additives

The composition may optionally contain stabilizers and optional additives. In particular, the composition may include a stabilizer or a radical scavenger, such as Irgastab UV 10 (Ciba Specialty Chemicals, Inc., Basel, Switzerland). Optional additives include, but are not limited to, thixotropic agents, wetting agents, foaming agents, antifoaming agents, flow agents, plasticizers, dispersants, surfactants, and the like. The composition may also include an inhibitor, preferably a hydroquinone, to stabilize the composition by prohibiting or, at least, delaying polymerization of the oligomer and monomer components during storage, thus increasing the shelf life of the composition. However, additives may negatively affect cure rate, and care should be taken when formulating a composition using such optional additives.

The total amount of stabilizers included in the ink may be from, for example, about 0.01 to about 2%, preferably from about 0.1 to about 1.5%, by weight based on total composition.

Preferably, the composition does not contain any solvents or vehicles because the phase change polymer behaves as a solvent or vehicle at the ink jet operation temperatures.

### Crystalline Silicon Wafer Solar Cells

The composition is used to fabricate grid lines of the solar cells with high aspect ratio in order to improve cell efficiency. A conventional solar cell structure with a p-type base has a negative electrode that is typically on the front-side or sun side of the cell and a positive electrode on the backside. It is well-known that radiation of an appropriate wavelength falling on a p-n junction of a semiconductor body serves as a source of external energy to generate hole-electron pairs in that body. Because of the potential difference which exists at a p-n junction, holes and electrons move across the junction in opposite directions and thereby give rise to flow of an electric current that is capable of delivering power to an external circuit. Most solar cells are in the form of a silicon wafer that has been metalized, i.e., provided with metal contacts that are electrically conductive.

FIG. 1 shows cross section diagram of an exemplary wafer solar cell (p-type silicon wafer) before a firing process. In FIG. 1, layer 10 is the p-type silicon substrate, which can be either single or multi-crystalline Si. An n-type diffusion layer, 20, of the reverse conductivity type is formed by a thermal diffusion of phosphorus (P) or the like. Phosphorus oxychloride (POCl₃) is commonly used as the phosphorus diffusion source. This diffusion layer has a sheet resistivity on the order of several tens of ohms per square (Ω/□), and a thickness of about 0.3 to 0.5 μm. Next, a silicon nitride film, 30, is formed as an anti-reflection coating on the n-type diffusion layer, 20, to a thickness of about 70 to 90 nm by a process such as thermal CVD, PECVD or sputtering. A silver paste (e.g. in form of grid lines and bus bars), 100, which is the composition of the present invention, for the front electrode is printed by such technique as screen print or ink jet print, then dried over the silicon nitride film, 30. In addition, a backside silver or silver/aluminum paste, 70, and an aluminum paste, 60, are then screen printed and dried on the backside of the substrate. Firing is then carried out in an infrared furnace at a temperature range of approximately 700 to 975° C. for a period from several minutes to several tens of minutes.

FIG. 2 is a cross section diagram of an exemplary wafer solar cell (p-type) after the firing process. The aluminum diffuses from the aluminum paste into the silicon substrate, 11, as a dopant during firing, forming a p+ layer, 41, containing a high concentration of aluminum dopant. This layer is generally called the back surface field (BSF) layer, and helps to improve the energy conversion efficiency of the solar cell. The aluminum paste is transformed by firing from a dried state from FIG. 1, 60, to an aluminum back electrode, 61. The backside silver or silver/aluminum paste of FIG. 1, 70, is fired at the same time, becoming a silver or silver/aluminum back electrode, 71. During firing, the boundary between the backside aluminum and the backside silver or silver/aluminum assumes an alloy state, and is connected electrically well. The aluminum electrode accounts for most areas of the back electrode, owing in part to the need to form a p+ layer, 41. Because soldering to an aluminum electrode is impossible, a silver back electrode is formed over portions of the backside as an electrode for interconnecting solar cells by means of copper ribbon or the like. In addition, the front electrode-forming silver paste, 101 which is the composition of the present invention, sinters and penetrates through the silicon nitride film, 31, during firing, and is thereby able to electrically contact the n-type layer, 21. This type of process is generally called “fire through.” This fired through state is shown in layer 101 of FIG. 2

### EXAMPLES

### Example 1

### Dispersion of the Composition

Into a 4 ounce (118 ml) glass bottle was added 24.118 g CD406 (Sartomer Co., Inc., Exton, Pa.), 1.317 g Irgacure 379, 0.263 g Irgacure 2959, 0.527 g Darocure ITX, and 0.105 g Irgastab UV10 (all from Ciba Specialty Chemicals, Inc., Basel, Switzerland). The above mixture was placed on a 90-100° C. heating bath and mixed well after melting. Into the bottle was added 21.919 g Ag powder (Ferro 7000-35, Ferro Co., Electronic Materials Systems, South Plainfield, N.J.), 0.997 g ZnO (Alfa Aesar nano ZnO, #44299, Ward Hill, Mass.), and 0.741 g of a lead borosilicate glass frit (23.0% SiO₂, 0.4% Al₂O₃, 58.8% PbO, 7.8% B₂O₃, 6.1% TiO₂, 3.9% CdO, all by weight percent.); the resulting mixture was dispersed with a ¼″ (6.3 mm) ultrasound probe (Dukane Co., Model 40TP200, Transducer Model 41C28, St. Charles, Ill.) for 25 minutes, during which time the mixture was manually stirred with a spatula at 3 to 5 minute intervals. The resulting dispersion was filtered with 2.7μ Whatman® MGF syringe-disk filter while hot.

### Example 2

### Ink Jet Printing of the Composition and Cell Making

The printing was carried out with a MicroFab Lab Jet II ink jet printer (MicroFab Technologies, Inc., Plano, Tex.). A PH-04 polymer Jet print head capable of heating up to 240° C. was used to maintain the print head operation temperature (cartridge chamber and dispensing device) around 90° C. A dispensing device with a 50μ nozzle was used for most of the printing work (MJ-SF-04). Printing drops were adjusted in such a manner that uniform drops were produced. 28 mm×28 mm p-type multicrystalline wafers with a thin PECVD silicon nitride antireflective layer and a sheet resistance of approximately 65 ohms/square were used as the printing substrates. The back side of the wafer was covered with an Al-based paste by screen printing. Curing of the front side lines was carried out by exposing to a BLAK-RAY® long wave UV lamp; model B 100 AP (UVP, Upland, Calif.) for 30 minutes. The cells were fired in a belt furnace at peak temperatures of 800 to 900° C. with a rapid heating profile.

What is claimed is:

1. A composition comprising by weight, based on total composition:
a) 30 to 98% silver powder having metal particles having an average particle size of 5 nm to 10 micron;
b) 0.1 to 15% of glass frit having frit particles wherein the frit particles have an average particle size of 5 nm to 5 micron;
c) 1 to 70% of a cross-linkable, phase change binder;
d) optionally, 0.1 to 8% of Zn containing particles wherein the Zn containing particles have an average particle size of 5 nm to 10 microns;
e) optionally, 0.01 to 10% of initiator; and
f) optionally, 0.0001 to 2% stabilizer.

2. The composition of claim 1 wherein the binder comprises at least one monomer or oligomer selected from acrylate, alkene, allylic ether, vinyl ether, alkyl epoxide, aryl epoxide, and optionally at least one wax selected from natural wax, modified wax, or synthetic wax.

3. The composition of claim 1 wherein the binder comprises at least one polymer selected from acrylate, alkene, allylic ether, vinyl ether, alkyl epoxide, aryl epoxide, and optionally at least one wax selected from natural wax, modified wax, or synthetic wax.

4. The composition of claim 2 wherein the binder is selected from cyclohexane dimethanol diacrylate; tris(2-hydroxy ethyl) isocyanurate triacrylate or a mixtures thereof.

5. The composition of claim 1 wherein the crosslinkable, phase change binder comprises monomers, oligomers or mixtures thereof being liquid at 50 to 240° C. and solid at 25° C.

6. A process comprising depositing a pattern of the composition of claim 1 on a substrate.

7. The process of claim 6 further comprising:
radiation curing the composition of claim 1; and
firing the composition.

8. The process of claim 6 further comprising:
radiation curing the composition of claim 5 and
firing the composition.

9. The process of claim 6 wherein the substrate is selected from the group consisting of a silicon wafer, solar cell, and photovoltaic module.

10. The process of claim 6 wherein the depositing the pattern is selected from the group consisting of ink jet printing and screen printing.

11. The process of claim 7 wherein phase change binder of the composition is cross-linked.

12. The process of claim 7 wherein the radiation curing is selected from the group consisting of UV exposure, e-beam exposure, thermal treatment, and combinations thereof.
